(19) United States
(12) Patent Application Publication
(10) Pub. No.: US 2013/0201411 A1
(43) Pub. Date: Aug. 8, 2013

(54) SCREEN ATTACHMENT STRUCTURE AND PROJECTION TELEVISION

(71) Applicant: Masataka NISHI, Tokyo (JP)

(72) Inventor: Masataka NISHI, Tokyo (JP)

(21) Appl. No.: 13/601,500

(22) Filed: Aug. 31, 2012

(30) Foreign Application Priority Data
Feb. 2, 2012 (JP) JP2012-020717

(51) Int. Cl. H04N 5/645

(52) U.S. Cl. 348/836; 348/E05.129

(57) ABSTRACT

An object of the present invention is to provide a screen attachment structure of a projection television excelling in design where the deflection of a screen caused by the expansion and contraction of the screen is suppressed, and screen defect is difficult to occur. A screen attachment structure according to the present invention includes a frame for fixing an end of a screen without a play space, an absorption mechanism for absorbing movement of the frame caused by the expansion and contraction of the screen, and a housing to which the frame is attached via the absorption mechanism.

### BACKGROUND OF THE INVENTION

1. Field of the Invention

The present invention relates to screen attachment structures, and in particular, to a screen attachment structure of a projection television.

2. Description of the Background Art

A screen used in the projection television (hereinafter referred to as PTV) generally has a property of expanding and contracting in a screen surface direction by expanding and contracting due to change in temperature and humidity.

The screen is normally attached to a housing by way of a frame for fixing an end of the screen.

If such screen attachment structure does not include an absorption mechanism for absorbing movement caused by the expansion and contraction of the screen, deflection may occur in the screen by such expansion and contraction and the screen may lose planarity, and hence pictures may not be appropriately projected.

The conventional absorption mechanism resolves the above problem by sandwiching an end of the screen and a screen holder having elasticity capable of fixing the end of the screen to a groove provided in the frame formed larger than the screen to fix the screen, and providing a play space where the screen can slidably move in the groove (see Japanese Patent Application Laid-Open Publication No. 7-92564).

There is also known a screen attachment structure for resolving the above problem by holding the end of the screen in the groove having a play space provided in the frame formed larger than the screen, similar to the above, via an elastic body for absorbing the movement caused by the expansion and contraction of the screen (see Japanese Utility Model Application Laid-Open Publication No. 4-4478).

Since the screen attachment structure of Japanese Patent Application Laid-Open Publication No. 7-92564 is a structure for absorbing the movement caused by the expansion and contraction of the screen with the groove for holding the end of the screen, the screen may slidably move and rub against the groove thus producing white powder during transportation, for example, and such white powder may attach to the screen, thus causing screen defect.

The screen attachment structure of Japanese Patent Application Laid-Open Publication No. 7-92564 and Japanese Utility Model Application Laid-Open Publication No. 4-4478 needs to design the frame width of the front surface of the television large by the amount of expansion and contraction of the screen to provide the groove having the play space in the frame formed larger than the screen and hold the end of the screen, that is, to arrange the absorption mechanism so as to bulge out to the side of the screen, and thus the degree of freedom in design is limited.

### SUMMARY OF THE INVENTION

It is an object of the present invention to provide a screen attachment structure excelling in design without having white powder produced from the screen and without bulging out to the side of the screen, and a projection television equipped with the same.

A screen attachment structure of a projection television according to the present invention includes a frame for fixing an end of a screen without a play space; and an absorption mechanism for absorbing movement of the frame caused by expansion and contraction of the screen. The screen attachment structure of the projection television according to the present invention further includes a housing to which the frame is attached via the absorption mechanism.

According to the present invention, the deflection of the screen can be suppressed since the movement of the frame caused by the expansion and contraction of the screen can be absorbed by the absorption mechanism arranged in the screen attachment structure.

Furthermore, white powder is not produced from the screen since the absorption mechanism is arranged via the frame, whereby the screen defect that occurs from the attachment of the white powder does not occur. It is preferable in terms of design since the frame fixes the end of the screen without a play space and hence the frame width seen from the front surface of the screen can be reduced by arranging the absorption mechanism on the rear surface of the screen.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view of a screen attachment structure according to a first preferred embodiment;

FIG. 2 is a view showing a contraction of a screen according to the first preferred embodiment;

FIG. 3 is a view showing an expansion of the screen according to the first preferred embodiment;

FIG. 4 is a cross-sectional view of a screen attachment structure according to a second preferred embodiment;

FIG. 5 is a cross-sectional view of a screen attachment structure according to a third preferred embodiment; and

FIG. 6 is a cross-sectional view of a screen attachment structure according to a fourth preferred embodiment.

### DESCRIPTION OF THE PREFERRED EMBODIMENTS

### First Preferred Embodiment

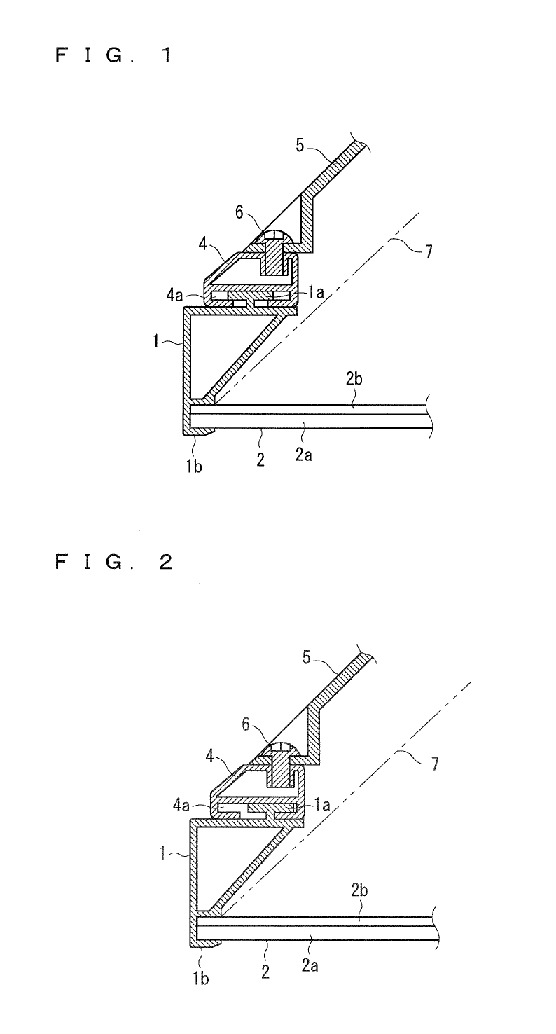

FIG. 1 shows a cross-sectional view of a screen attachment structure according to the present preferred embodiment. An image light exit from an optical engine (not shown) configured by a light source, a liquid crystal panel serving as a light modulator, a projection lens, and the like is passed via an inner side of a projection line 7 and projected onto a rear surface of a screen 2.

The screen 2 is configured by a screen front panel 2a for showing the projected projection light as a picture, and a screen rear panel 2b closely attached to the screen front panel 2a and on which the projection light is projected. An end of the screen 2 is fixed by a groove provided in a frame 1.

The frame 1 is supported by an auxiliary frame 4. The auxiliary frame 4 is fixed to a housing 5 by a bolt 6, for example. An absorption mechanism for absorbing the movement of the frame 1 caused by the expansion and contraction of the screen 2 is configured by a projection 1a provided on the frame 1 and the auxiliary frame 4 including a groove 4a to which the projection 1a is fitted in a freely slidably moving manner. As shown in FIG. 1, such absorption mechanism is arranged on the rear surface side of the screen 2.

The frame 1 is an appearance component that may become the design of the PTV, and is a component that requires a strength sufficient enough to fix the screen 2, and hence is generally made of a non-ferrous metal such as aluminum. The screen front panel 2a and the screen rear panel 2b are generally made of a plastic material.

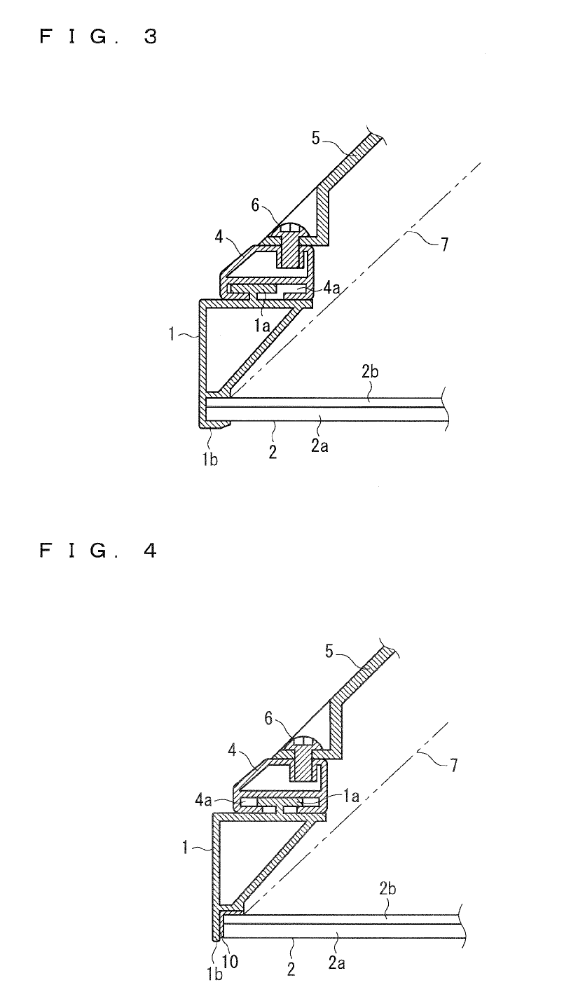

The movement of the absorption mechanism of the screen attachment structure according to the present preferred embodiment will be described using FIG. 2 and FIG. 3. For instance, when the temperature of the screen 2 lowers and the screen 2 contracts due to lowering in air temperature, the projection 1a of the frame 1 slidably moves in a contracting direction with respect to the groove 4a, thus absorbing the movement of the frame 1, that is, the movement of the screen (FIG. 2). When, for example, the temperature of the screen rises and the screen expands due to rise in the air temperature, the projection 1a similarly slidably moves with respect to the groove 4a, thus absorbing the movement of the frame 1 (FIG. 3).

<Effect>

The screen attachment structure in the present preferred embodiment is a screen attachment structure of the PTV, and includes the frame 1 for fixing the end of the screen 2 without a play space, the absorption mechanism for absorbing the movement of the frame 1 caused by the expansion and contraction of the screen 2, and the housing 5 to which the frame 1 is attached by way of the absorption mechanism.

Therefore, the movement of the frame 1 caused by the expansion and contraction of the screen 2 can be absorbed by the absorption mechanism, and hence the deflection of the screen 2 can be suppressed. Furthermore, since the frame 1 fixes the end of the screen 2 without a play space, a frame width 1b of the front surface of the television can be made small by arranging the absorption mechanism on the rear surface side of the screen 2, which is preferable in terms of design.

The absorption mechanism according to the present preferred embodiment includes the projection 1a provided on the frame 1, and the auxiliary frame 4 fixed to the housing 5 and including the groove 4a to which the projection 1a is fitted in a freely slidably moving manner.

Therefore, white powder does not produce from the screen even if the projection 1a and the groove 4a slidably move in the absorption mechanism, whereby the occurrence of screen defect caused by the attachment of the white powder to the screen 2 can be suppressed.

The absorption mechanism of the screen attachment structure in the present preferred embodiment is characterized in being provided on the rear side of the screen 2.

Therefore, the frame width 1b of the front surface of the television can be made smaller than the screen attachment structure of Japanese Patent Application Laid-Open Publication No. 7-92564 and Japanese Utility Model Application Laid-Open Publication No. 4-4478, whereby the screen attachment structure excelling in design can be achieved.

The PTV according to the present preferred embodiment includes the screen 2, the housing 5, and the screen attachment structure described in the present preferred embodiment for attaching the screen 2 to the housing 5. Therefore, the PTV according to the present preferred embodiment has effects similar to the effects of the screen attachment structure described above.

### Second Preferred Embodiment

In the first preferred embodiment, the end of the screen 2 is fixed by being sandwiched by the groove formed in the frame 1 to fix the end of the screen 2 by the frame 1 without a play space, but in the present preferred embodiment, the end of the screen 2 and the frame 1 are stuck and fixed with an adhesive 10, as shown in FIG. 4. According to the fixing method, a configuration in which the frame 1 does not cover the front surface of the screen can be achieved, and hence the frame width 1b can be thinned to the thickness of the frame 1.

Other structures are the same as the first preferred embodiment (FIG. 1), and thus the description will be omitted.

<Effects>

In the screen attachment structure according to the present preferred embodiment, the frame 1 is stuck and fixed to the end of the screen 2 by the adhesive 10 and thus does not cover the front surface of the screen 2. Therefore, the frame width 1 of the frame 1 seen from the front surface of the television can be made small to the thickness of the frame 1, whereby the screen attachment structure further excelling in design can be achieved.

The PTV according to the present preferred embodiment includes the screen 2, the housing 5, and the screen attachment structure described in the present preferred embodiment for attaching the screen to the housing. Therefore, the PTV excelling in design with small frame width 1b, as described above, can be achieved.

### Third Preferred Embodiment

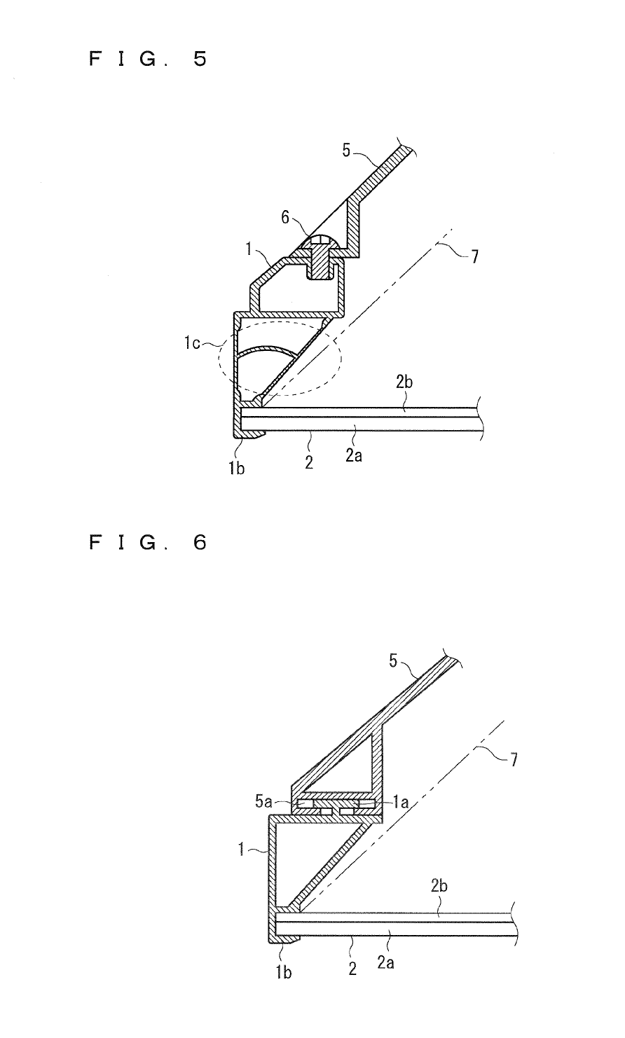

A cross-sectional view of a screen attachment structure according to the present preferred embodiment is shown in FIG. 5. Similar to the first preferred embodiment, the end of the screen 2 is fixed by the frame 1 without a play space, and the frame 1 is fixed to the housing 5 by the bolt 6, for example, at a housing attaching portion.

For the absorption mechanism for absorbing the movement of the frame 1 caused by the expansion and contraction of the screen 2, an elastic portion 1 c having an elasticity sufficient enough to absorb the movement of the frame 1 caused by the extension of the screen 2 is provided between the portion of the frame 1 for fixing the end of the screen 2 and the housing attaching portion of the frame 1.

The elastic portion 1c is, for example, made of the same material as the frame 1, and is provided with elasticity by being formed thin.

For instance, when the screen 2 is expanded or contracted due to change in temperature to move the portion for fixing the end of the screen 2 in the frame 1, the deflection of the screen 2 can be suppressed by absorbing the movement in the elastic portion 1c.

It is preferable in terms of design to stick and fix the end of the screen 2 to the frame 1 with the adhesive 10, as with the second preferred embodiment, since the frame width 1b of the front surface of the television can be made smaller.

The absorption mechanism arranged in the screen attachment structure of the present preferred embodiment includes the elastic portion 1c provided between the portion of the frame 1 for fixing the end of the screen 2 and the portion of the frame 1 for attaching the housing 5. The PTV according to the present preferred embodiment includes the screen 2, the housing 5, and the screen attachment structure described in the present preferred embodiment for attaching the screen to the housing.

Therefore, compared to the first preferred embodiment (FIG. 1), the number of components can be reduced since the auxiliary frame 4 is not used, and the effect of reducing the manufacturing cost can be further expected in addition to the effects described in the first preferred embodiment.

### Fourth Preferred Embodiment

A cross-sectional view of a screen attachment structure according to the present preferred embodiment is shown in FIG. 6. The present preferred embodiment is a screen attachment structure in which the auxiliary frame 4 in the first preferred embodiment (FIG. 1) is not given. In the present preferred embodiment, the frame 1 is fixed to the housing 5 via the absorption mechanism. The absorption mechanism includes the projection 1a provided on the frame 1 and a groove 5a formed in the housing 5 and adapted to have the projection 1a fitted in a freely slidably moving manner. The other screen attachment structure is the same as the first preferred embodiment, and thus the description will be not given.

When the frame 1 moves by the expansion and contraction of the screen 2, the projection 1a and the groove 5a slidably move to absorb the movement of the frame 1 in the absorption mechanism described above, thus suppressing the deflection of the screen 2.

It is preferable in terms of design to stick and fix the end of the screen to the frame 1 with the adhesive 10, as in the second preferred embodiment, since the frame width 1b can be made smaller.

The absorption mechanism arranged in the screen attachment structure according to the present preferred embodiment includes the projection 1a provided on the frame 1 and the groove 5a formed in the housing 5 and adapted to have the projection 1a fitted in a slidably moving manner. Therefore, in addition to the effects described in the first preferred embodiment, the number of components can be reduced since the auxiliary frame 4 (FIG. 1) is not used and the effect of reducing the manufacturing cost is further expected, similar to the third preferred embodiment.

The PTV according to the present preferred embodiment includes the screen 2, the housing 5, and the screen attachment structure described in the present preferred embodiment for attaching the screen to the housing. Therefore, PTV can be manufactured with reduced manufacturing cost, as described above.

The present invention can be contrived by freely combining each preferred embodiment within a scope of the invention, where each preferred embodiment may be appropriately modified and omitted.

While the invention has been shown and described in detail, the foregoing description is in all aspects illustrative and not restrictive. It is therefore understood that numerous modifications and variations can be devised without departing from the scope of the invention.

What is claimed is:

1. A screen attachment structure of a projection television comprising:
a frame for fixing an end of said screen without a play space;
an absorption mechanism for absorbing movement of said frame caused by expansion and contraction of said screen; and
a housing to which said frame is attached via said absorption mechanism.

2. The screen attachment structure according to claim 1, wherein said absorption mechanism includes,
a projection provided on said frame, and
an auxiliary frame fixed to said housing and including a groove to which said projection is fitted in a freely slidably moving manner.

3. The screen attachment structure according to claim 1, wherein said absorption mechanism includes an elastic portion provided between a portion of said frame for fixing the end of said screen and a portion of said frame for attaching said housing.

4. The screen attachment structure according to claim 1, wherein said absorption mechanism includes,
a projection provided on said frame, and
a groove provided in said housing and to which said projection is fitted in a freely slidably moving manner.

5. The screen attachment structure according to claim 1, wherein said frame is stuck and fixed to the end of said screen and does not cover a front surface of said screen.

6. The screen attachment structure according to claim 1, wherein said absorption mechanism is provided on a rear surface side of said screen.

7. A projection television comprising:
a screen;
a housing; and
a screen attachment structure for attaching said screen to said housing; wherein
said screen attachment structure includes,
a frame for fixing an end of said screen without a play space, and
an absorption mechanism for absorbing movement of said frame caused by expansion and contraction of said screen; and
said frame is attached to said housing via said absorption mechanism.
